(19) United States
(12) Patent Application Publication
(10) Pub. No.: US 2015/0345613 A1
(43) Pub. Date: Dec. 3, 2015

(54) TRANSFER CASE SUPPORT SYSTEM

(71) Applicant: White Rock II, LLC, Logan, UT (US)

(72) Inventor: John Williams, Salt Lake City, UT (US)

(73) Assignee: VVhite Rock II, LLC, Logan, UT (US)

(21) Appl. No.: 14/720,888

(22) Filed: May 25, 2015

Related U.S. Application Data
(60) Provisional application No. 62/003,520, filed on May 27, 2014.

(51) Int. Cl. F16H 57/03

(52) U.S. Cl. CPC F16H 57/03; F16H 2057/02043

(57) ABSTRACT

A new and innovative transfer case support system is provided. The problem of transfer case failure due to stressing forces in off-road conditions is solved. Embodiments of the present invention include a transfer case support system, comprising a scaffold releaseably attachable to an outer surface of a vehicle transfer case, said scaffold configured to stabilize the transfer case against stressing forces when a vehicle is in operation, said scaffold further comprising two or more separable portions configured to interlock when the scaffold is releaseably attached to the outer surface of the vehicle transfer case.

### CROSS-REFERENCE TO RELATED APPLICATIONS

This application claims priority to U.S. Provisional Application No. 62/003,520, filed on May 27, 2014.

### BACKGROUND OF THE INVENTION

The machinery of off-road vehicles can be subject to punishing and extreme conditions, whether the conditions are recreational, sustained off-road use, or competitive racing. The essential transfer case is no exception. Even the best designed stock transfer cases can be subject to serious damage or catastrophic failure as a result of off-road conditions. One or more dymanics may contribute to this. First, off-road conditions may cause U-joint wear and subsequent imbalance in the drive line, resulting in stress the transfer case. Second, jumping and landing an off-road vehicle may create compression forces exceeding the transfer case's ability to handle them. Third, low gear usage may increase rotation dynamics within the transfer case, leading to excessive pressure and failure. In any event, transfer cases in off-road vehicles are vulnerable to these types of stressing forces.

### SUMMARY OF THE INVENTION

In accordance with the above, a new and innovative transfer case support system is provided. The problem of transfer case failure due to stressing forces in off-road conditions is solved. Embodiments of the present invention include a transfer case support system, comprising a scaffold releaseably attachable to an outer surface of a vehicle transfer case, said scaffold configured to stabilize the transfer case against stressing forces when a vehicle is in operation, said scaffold further comprising two or more separable portions configured to interlock when the scaffold is releaseably attached to the outer surface of the vehicle transfer case.

These and other aspects of the present invention will become more fully apparent from the following description and appended claims, or may be learned by the practice of the invention as set forth hereinafter.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is an exploded perspective view of a transfer case support system.

FIG. 2 is a perspective view of the transfer case support system.

FIG. 3 is an exploded perspective view of a transfer case support system.

FIG. 4 is a front perspective view of a transfer case support system in a transfer case environment.

FIG. 5 is a right side-top perspective view of a transfer case support system in a transfer case environment.

FIG. 6 is a left side-top perspective view of a transfer case support system in a transfer case environment.

### DETAILED DESCRIPTION OF THE ILLUSTRATED EMBODIMENT

The present invention in its various embodiments, some of which are depicted in the figures herein, is a transfer case support system.

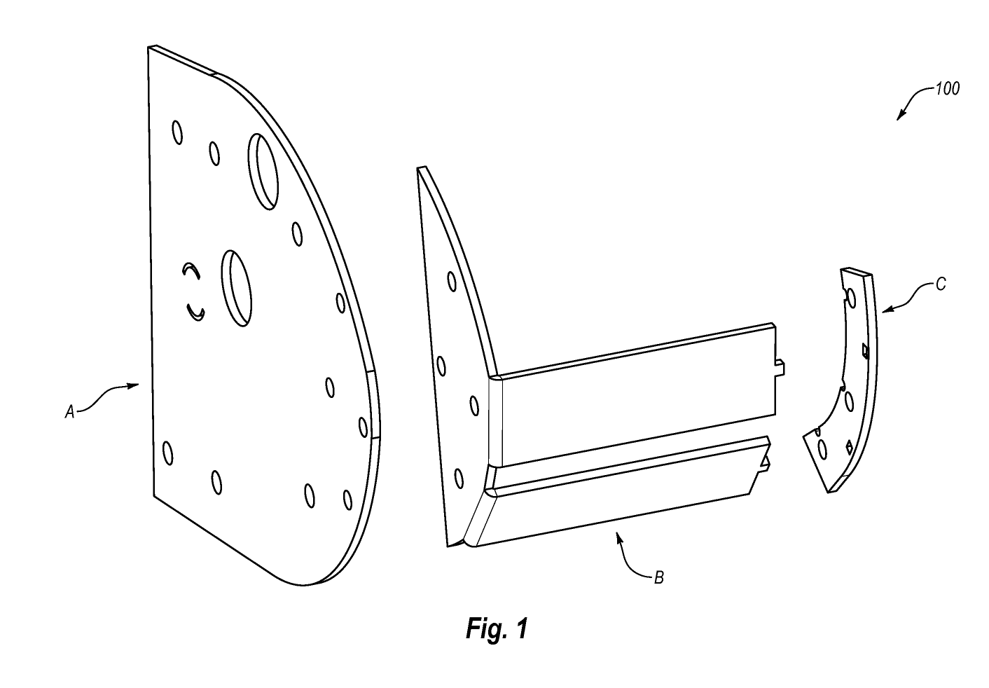

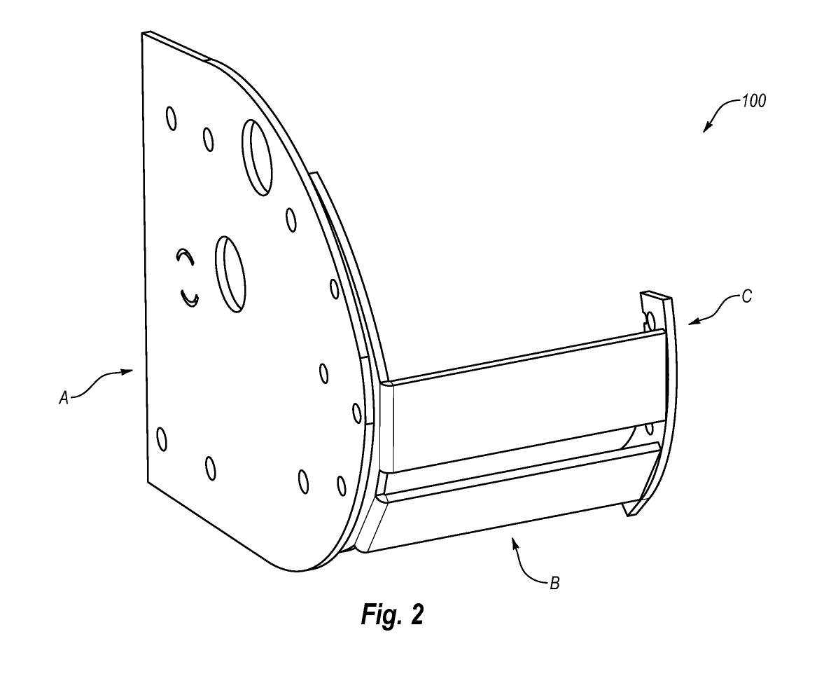

Referring now to FIG. 1, an exploded perspective view of a transfer case support system 100 is shown. Importantly, the various Figures herein depict the system upside down from how it would be oriented when attached to a vehicle; however, for simplicity, illustration, and reference the orientation is reversed in this description in order to better depict the features of the system (top would be bottom when the system is on the vehicle). In preferred embodiments, the support 100 is essentially a scaffold releasably attachable to a transfer case on a vehicle. In some embodiments, the support 100 is comprised of three main sections: A, B, and C. Various embodiments may combine Sections B and Section C as a single, integral unit. Section A forms a first side of the support, Section C forms a second side of the support, and Section B is a connecting member between Sections A and C. When in use, Sections A, B, and C are configured to attach and/or interlock together (see FIGS. 2 & 4) around a transfer case and form an external skeleton for the transfer case with connections located at key points. So, configured, the system provides extreme strength to hold the transfer case together against opposing pressures and forces described above and frequently encountered in off-road vehicle use.

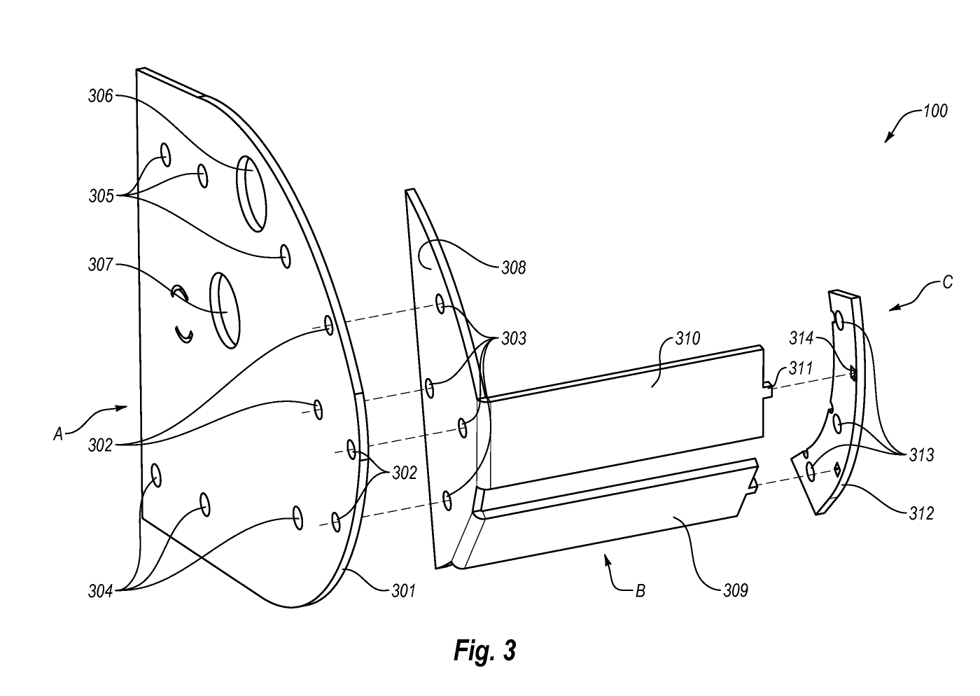

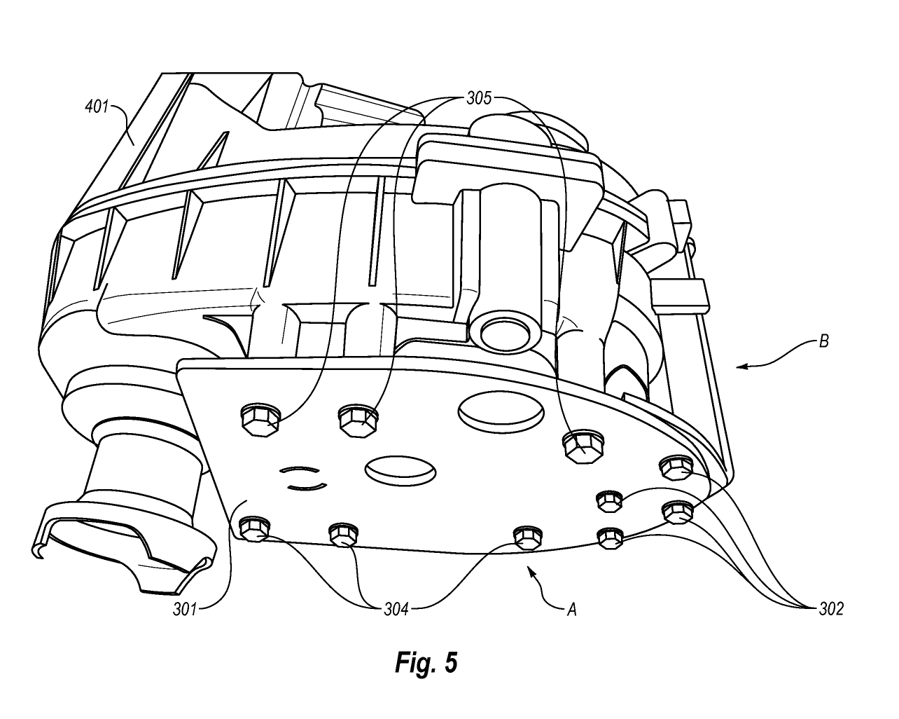

The support system may be further understood by referring to the detail of FIG. 3. Section A is comprised of a plate 301 with apertures. In some embodiments the plate 301 is shaped as an elongated (in width) “D” to substantially correspond to the shape of a side profile of the transfer case (see FIG. 5).

In preferred embodiments, Section A's plate 301 has four types of apertures: First, the plate 301 has a one or more first apertures 302 for connecting Section A and Section B. Some of these apertures 302 may be located adjacent to the front of the plate 301. The location of the one or more first apertures 302 on the front of the plate 301 corresponds to the location of one or more apertures 303 on a portion of Section B. In operation, the one or more first apertures 302 are capable of receiving bolts with nuts or other fastener types to removeably attach Section A to Section B. In the illustrated embodiment, there is a set of four first apertures 302.

Second, the plate 301 has one or more second apertures 304, 305 for releaseably attaching Section A to the transfer case. These second apertures may be located adjacent to the bottom or top of the plate 301. The location of the one or more second apertures 304, 305 corresponds to the location of one or more existing bolts on a stock transfer case (not shown). In operation, the plate's 301 one or more second apertures 304, 305 are capable of receiving one or more transfer case bolts to removeably attach Section A directly to the transfer case (see, e.g., FIG. 5). In the illustrated embodiment, there are two sets (of three) second apertures 304, 305.

Third, the plate 301 has one or more third apertures 306 located adjacent to the top of the plate 301. The location of the one or more third apertures 306 corresponds to the location of a transfer case feature which may include, but is not limited to, a drain and fill plug.

Fourth, the plate 301 has one or more fourth apertures 307 the location of which corresponds to the location of transfer case identification labels. In operation, the one or more third and/or fourth apertures 306, 307 allow a user to access and/or manipulate a transfer case feature (such as referenced above) from outside the system.

Section B is comprised of a plate 308 with apertures 303 and one or more cross bars 309, 310 that are positioned at the front of and roughly perpendicular to the plate 308. In operation, cross bars 309, 310 have the dual purpose of shielding the transfer case from frontal impacts, in addition to stabilizing the transfer case. As set forth above, the location of the one or more apertures 303 of Section B corresponds to the location of the one or more first apertures 302 on Section A. Again, in operation, Section B's one or more apertures 303 are capable of receiving bolts and nuts and/or other fasteners to removeably attach Section B to Section A. In the illustrated embodiment, Section B has four such apertures. Also, terminal portions of one or more cross bars 309, 310 may have a key 311 that corresponds to a key hole 314 in Section C to fit and/or interlock Section B to Section C.

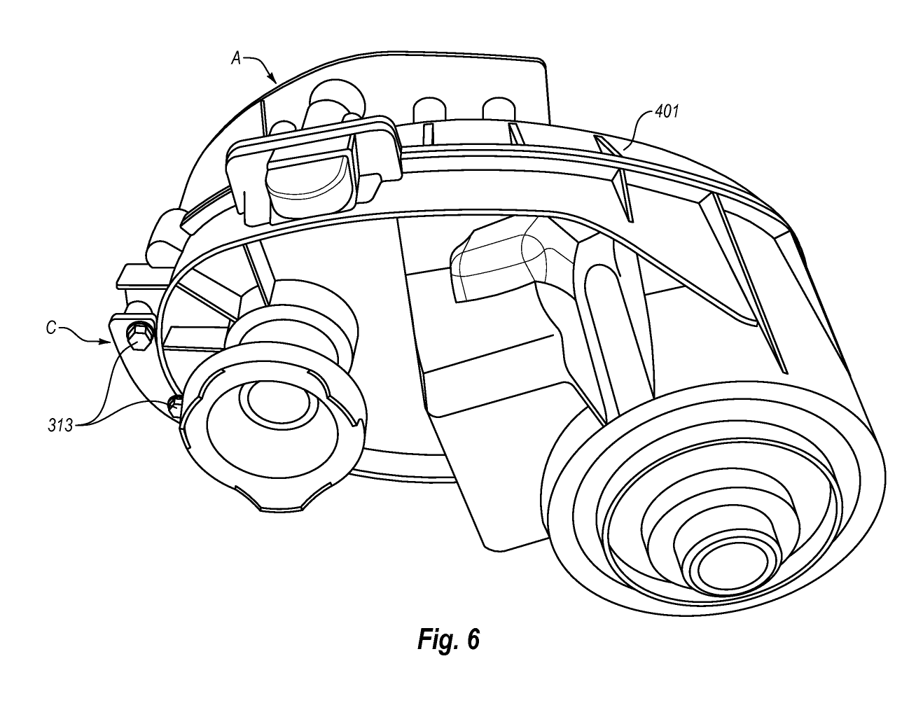

Section C is comprised of a plate 312 with apertures 313, 314. In various embodiments, Section C's plate 312 has two types of apertures: first, one or more first apertures 313 is located along the plate 312 and correspond to the location of one or more existing bolts on a transfer case (not shown). In operation, Section C's one or more first apertures 313 are capable of receiving one or more transfer case bolts to removeably attach Section C directly to the transfer case (see FIG. 6). Second, one or more second apertures 314 are key holes that correspond to the key 311 of Section B to fit and/or interlock Section B to Section C when the scaffold is releasably attached to the transfer case.

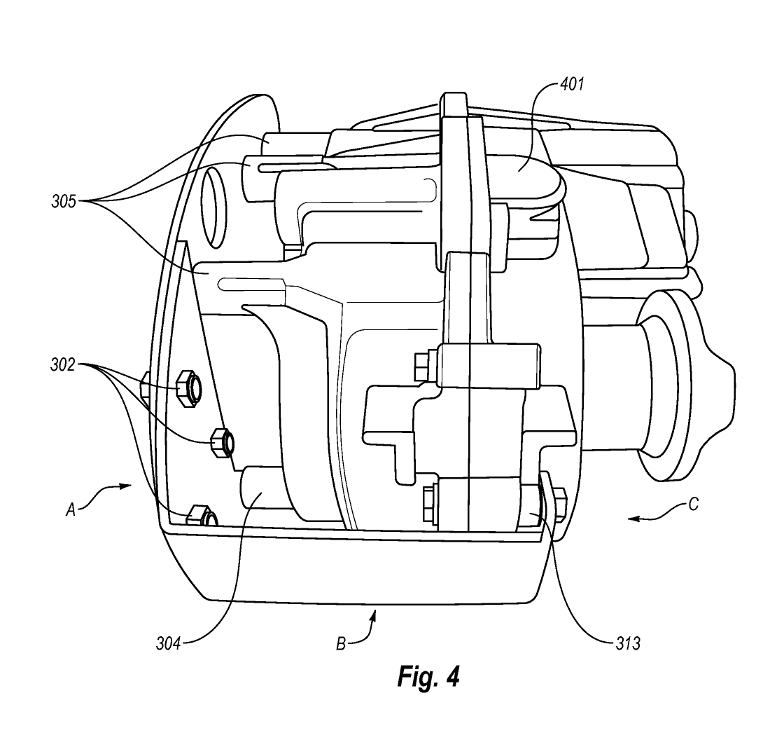

Referring now to FIGS. 4-6, the system 100 is shown releasably attached to and forming a skeleton or scaffold around a transfer case 401. In the illustrated embodiment, the scaffold is configured to generally contour a portion of the transfer case when the scaffold is releasably attached to the transfer case. As described above, Section A's one or more first apertures receives a bolt to removeably attach Section A to Section B. Section A's one or more second apertures 304 and third apertures 305 receives a bolt to removably attach Sections A and B directly to the transfer case 401 through existing transfer case bolt receivers. Section C's one or more first apertures 313 receives a bolt to removably attach Section C directly to the transfer case 401 through existing transfer case bolt receivers.

In various embodiments, Sections A, B and/or C are made of 3/16″ metal, although it is understood that a variety of materials and dimensions may be utilized without departing from the purpose and scope of the invention.

Thus configured, embodiments of the present invention provide a transfer case support system for use in a variety of applications. The problem of transfer case failure due to off-road conditions is solved by providing system that forms an external skeleton and shield to the transfer case, stabilizing it against internal and external pressures and forces. In particular, so configured, the transfer case support system protects a vehicle transfer case against stressing forces including U-joint wear and subsequent imbalance in the drive line, jumping and landing compression forces, and low gear usage increasing rotation dynamics within the transfer case, among others.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A transfer case support system, comprising:
a scaffold releaseably attachable to an outer surface of a vehicle transfer case, said scaffold configured to stabilize the transfer case against stressing forces when a vehicle is in operation,
said scaffold further comprising two or more separable portions configured to interlock when the scaffold is releaseably attached to the outer surface of the vehicle transfer case.

2. The transfer case support system of claim 1, wherein the scaffold is configured to generally contour a portion of the transfer case when the scaffold is releaseably attached to the transfer case.

3. The transfer case support system of claim 1, the scaffold further comprising:
a first side support configured for placement adjacent to a first side of the vehicle transfer case,
a second side support configured for placement adjacent to a second side of a vehicle transfer case,
a connecting member configured for placement adjacent to a front of the vehicle transfer case and further configured to connect said first and second side supports when the scaffold is releaseably attached to the vehicle transfer case.

4. The transfer case support system of claim 3, wherein the first side support is a plate.

5. The transfer case support system of claim 3, the first side support having one or more first apertures for connecting the first side support to the connecting member with one or more fasteners.

6. The transfer case support system of claim 3, the first side support having one or more second apertures with a position corresponding to the position of one or more transfer case bolt receivers on the vehicle transfer case, said one or more second apertures configured to receive a fastener for removeably attaching the first side support to the vehicle transfer case.

7. The transfer case support system of claim 3, the first side support having a third aperture with a position corresponding to the position of a drain and fill plug on the vehicle transfer case and configured to provide access to the drain and fill plug.

8. The transfer case support system of claim 3, wherein the first side support has a fourth aperture with a position corresponding to the position of an identification label on the vehicle transfer case and configured to provide access to an identification label on the vehicle transfer case.

9. The transfer case support system of claim 3, the connecting member further comprising a plate with one or more cross bars in front of and roughly perpendicular to the plate.

10. The transfer case support system of claim 3, the second side support having one or more first apertures with a position corresponding to the position of one or more transfer case bolt receivers on the vehicle transfer case, said second side support first apertures configured to receive fasteners for removeably attaching the second side support to the vehicle transfer case.

11. The transfer case support system of claim 3, wherein the connecting member is configured to releaseably interlock with the first side support and second side support to form the scaffold.

12. A transfer case support system, comprising:
a scaffold releaseably attachable to an outer surface of a vehicle transfer case,
said scaffold configured to stabilize the transfer case against stressing forces when a vehicle is in operation,
said scaffold further comprised of
a first side support configured for placement adjacent to a first side of the vehicle transfer case, the first side support having one or more first apertures for connecting the first side support to a connecting member, the first side support further having one or more second apertures with a position corresponding to the position of one or more transfer case bolt receivers on the vehicle transfer case, said one or more second apertures configured to receive a fastener for removeably attaching the first side support to the vehicle transfer case,
a second side support configured for placement adjacent to a second side of a vehicle transfer case, the second side support having one or more first apertures with a position corresponding to the position of one or more transfer case bolt receivers on the vehicle transfer case, said second side support first apertures configured to receive fasteners for removeably attaching the second side support to the vehicle transfer case, and
a connecting member comprising a plate with one or more cross bars in front of and roughly perpendicular to the plate, the connecting member configured to releaseably interlock with the first side support and second side support to form the scaffold.
said scaffold further configured to generally contour a portion of the transfer case when the scaffold is releaseably attached to the transfer case.

13. The transfer case support system of claim 12, wherein the first side support has a third aperture with a position corresponding to the position of a drain and fill plug on the vehicle transfer case and configured to provide access to the drain and fill plug.

14. The transfer case support system of claim 12, wherein the first side support has a fourth aperture with a position corresponding to the position an identification label on the vehicle transfer case and configured to provide access to an identification label on the vehicle transfer case.

15. The transfer case support system of claim 12, the first side support comprising a plate shaped as an elongated D to substantially correspond to the shape of a side profile of the transfer case.

16. The transfer case support system of claim 12, the connecting member having a terminal portion on one or more ends with a key configured to correspond to a key aperture on the second side support for interlocking the connecting member with the second side support when the scaffold is releasably attached to the transfer case.
